(19) United States
(12) Patent Application Publication
(10) Pub. No.: US 2020/0207554 A1
(43) Pub. Date: Jul. 2, 2020

(54) DEVICE FOR COATING CONTAINERS BY MEANS OF A COATING PROCESS AND METHOD FOR OPERATING SUCH A DEVICE

(71) Applicant: KHS CORPOPLAST GMBH, Hamburg (DE)

(72) Inventors: Sebastian KYTZIA, Todesfelde (DE); Joachim KONRAD, Duesseldorf (DE); Michael HERBORT, Hamburg (DE)

(73) Assignee: KHS CORPOPLAST GMBH, Hamburg (DE)

(21) Appl. No.: 16/643,784

(22) PCT Filed: Sep. 7, 2018
(86) PCT No.: PCT/EP2018/074076

§ 371 Date: Mar. 2, 2020

(30) Foreign Application Priority Data
Sep. 7, 2017 (DE) 10 2017 120 650.7

(51) Int. Cl. B65G 47/90; B65D 23/08; B65D 23/02

(52) U.S. Cl. CPC B65G 47/902; B65D 23/02; B65D 23/0807; B65G 47/907

(57) ABSTRACT

A device for coating containers using a coating process with a main supporting frame, which includes: a container conveying device, a treatment station for coating the containers, and a transfer device, which moves the containers between the conveying device and the treatment station. The transfer device has a gripper unit, which is mounted pivotably along a pivot axis aligned parallel to the conveying device on a gripper frame, which is arranged fixed in place in relation to the main supporting frame during operation. The gripper unit is mounted on a carriage connected to the gripper frame. Thee carriage performs linear movements in three mutually perpendicular directions. The gripper unit is movable between a first position, in which it can grip the containers in the region of the conveying device, and a second position, in which it can insert the containers into the treatment station and fetch them from it.

### FIELD OF INVENTION

The present invention relates to a device for coating containers by means of a coating process, in particular a CVD process, and a method for operating such a process.

### BACKGROUND OF INVENTION

Container coating machines known from the prior art are used, among other functions, for coating the inner surfaces of containers, such as PET bottles. With such systems, the containers are conveyed into a conveying region, from there brought by means of a transfer device to a device and transferred to this, by means of which a process gas is introduced into the container and its inner surface is thereby coated. After coating has taken place, the transfer device brings the container back into the conveying region. From there it is conveyed out and passes into the further production chain.

DE 10 2010 023 119 A1 discloses a device for the plasma treatment of workpieces, with which the workpiece is treated in a plasma chamber which can be at least partially evacuated. The plasma chamber is arranged on a plasma wheel which is capable of rotating, and which comprises a number of cavities on which the workpieces are placed in order for the treatment to be carried out. These cavities, and the plasma stations connected to them must be rotated together with the plasma wheel. The loading of the plasma wheel with workpieces takes place after the delivery conveying of the workpieces by way of a transfer wheel and an inlet wheel. After the treatment has been carried out, the workpieces are transferred from the plasma wheel to an outlet wheel. From there they pass into the region of an outlet path and are conveyed out. Such an arrangement is very elaborate to operate, since a large number of plasma stations is necessary, which also have to rotate with the system.

WO 2010/054206 A2 discloses a device for manufacturing semiconductor component elements, which comprises a main carrier frame, on which, among other components, two treatment stations are provided, for processing in each case an individual substrate. The substrates are moved by means of a robot from a container on the main carrier frame into the treatment stations.

E 199 22 873 A1 discloses a device for delivering containers into a treatment space in which the containers are coated and then removing them from it. Provided between a delivery/removal conveying device is a lock-type rotor unit, which comprises gripping and holding devices. The lock-type rotor moves the containers between the delivery/removal conveying device and the treatment space, in each case by means of a pair of star wheels, arranged in the one case between the rotor and the delivery/removal conveying device and, in the other, between the delivery/removal conveying device and the treatment space, wherein each of the star wheels comprises in each case gripping and holding devices.

### SUMMARY OF THE INVENTION

The object of the present invention is to provide an alternative device and a method for the plasma coating of containers which overcome the disadvantages of the prior art.

This object is solved according to the invention by a device with the features of claim 1. According to this, provision is made that inside the main carrier frame are a treatment station for the coating of containers, a treatment station for the coating of the containers, a transfer device, which moves the containers between the conveying device and treatment station. At least one conveying device is also included, or the units referred to can be connected to at least one conveying device. The transfer device comprises a gripper unit, which is arranged such that it can be pivoted, along a pivot axis aligned parallel to the conveying device, at a gripper frame, which during the operation of the device is arranged in a fixed position on the main carrier frame and/or is part of the main carrier frame. As a result of the pivoting movement of the gripper unit about the pivot axis aligned parallel to the conveying device, several grippers can be formed on the gripper unit, and, when the containers are rotated at the grippers, there is no collision between the containers, even though the containers are rotated in close proximity to one another, in the same way as they were taken from the conveying device, by contrast with the situation in which a rotation of the containers were to be carried out about pivot axes parallel to the gripper longitudinal axis. Due to the fact that the gripper unit can move between a first position, in which it can grip the containers in the region of the conveying device, and a second position, in which it can place the containers into the treatment station and fetch them out of it, including a pivot movement about the pivot axis, a good and rapid transfer can be achieved of the untreated containers from the conveying device to the treatment station, and, after the treatment of the treated containers, from the treatment station to the conveying device.

An advantageous further embodiment makes provision for the gripper unit to be located on a carriage connected to the gripper frame, and the carriage can carry out linear movements in three directions running perpendicular to one another. As a result, the gripper unit can also be used such as to serve several treatment stations, and it can be used in a flexible manner, for example with regard to the movement curve which the containers carry out when undergoing the transfer from the conveying device to a treatment station.

A further advantageous embodiment of the invention makes provision for the conveying device to comprise two parts, an inlet conveying device and an outlet conveying device, and/or comprises a first part station and a second part station. Due to the division of the conveying device, a separate drive of the inlet conveying device and the outlet conveying device is possible, such that these are only driven when the particular present situation requires this. As a result, the removal of the containers from the inlet conveying device and the return of the containers to the outlet conveying device can be carried out with greater precision. Due to the division of the treatment station, a higher throughput can also be achieved, since the treatment can be carried out in the one part station, while the other part station is being loaded or unloaded.

A further advantageous embodiment of the invention makes provision for the gripper frame, together with the transfer device mounted on it, to be lowered in relation to the main carrier frame when it is not in operation. As a result, access to the individual components of the coating device is improved, in order, for example, for maintenance work to be carried out more easily.

A further advantageous embodiment of the invention makes provision for the gripper unit to comprise four grippers, which can be moved towards one another. As a result, throughput can be increased, since four containers can be moved simultaneously backwards and forwards between the treatment station and the conveying device. This applies in particular in connection with the division of the treatment station into two separate part stations as referred to heretofore.

A further advantageous embodiment of the invention makes provision for the spacing interval between adjacent grippers to be adjustable axially to the pivot axis. As a result, it is possible for containers of widely differing sizes to be processed without the need for any modifications to the conveying device or the treatment station. The change in the spacing interval is necessary with such containers of different sizes, since the spacing interval between the treatment positions in the treatment station can only be changed with very great effort, but the spacing interval between the containers is regularly also very different when they are inlet on the conveying device. This difference in size is compensated for and evened out during the movement from the conveying device to the treatment station, and the same applies on the return path.

A further advantageous embodiment of the invention makes provision for the grippers to be movable along their longitudinal axis. This also makes it easier for containers to be loaded into treatment stations of which the treatment positions are not arranged on a straight line in relation to one another, but which are located on a circular line segment or even on a curve of any desired configuration.

A further advantageous embodiment of the invention makes provision for the conveying device to have a railing, with which at least the part arranged on its side facing towards the treatment station can be lowered or pivoted away. As a result, it is not necessary for the containers, after being gripped by the gripper unit, first to be raised by a certain amount and only then for the pivoting process to be initiated, if appropriate followed by a linear movement of the transfer device, which can also be carried out simultaneously with the pivoting process. As a result, as well as simplifying the movement sequence, time is also saved.

The object is also solved by a method with the features of claim 10. According to this, provision is made for the following steps to be carried out by a device according to the invention:

a) inlet conveying of containers by the conveying device;

b) gripping of containers by the gripper unit on the conveying device;

c) raising of the gripper unit together with the containers;

d) pivoting of the gripper unit about the pivot axis;

e) linear movement of the gripper unit until the containers are located in the treatment station;

f) release of the containers by the gripper unit;

g) carrying out the coating;

h) gripping the containers by the gripper in the treatment station;

i) linear movement and pivoting of the gripper unit until the containers are located above the conveying device;

j) placing the containers down on the conveyor device and releasing them by the gripper unit;

k) outlet conveying of the containers by the conveying device.

This allows the advantages of the device according to the invention as referred to heretofore to be achieved.

A further advantageous embodiment of the invention makes provision that during, steps d and/or e, a change is made in the spacing intervals between adjacent grippers axially to the pivot axis, and this change is then reversed during steps i and/or j. As a result, the change is attained as referred to heretofore in the axial spacing interval of adjacent grippers, related to the pivot axis.

A further advantageous embodiment of the invention makes provision for the gripper unit to comprise four grippers, and the change of spacing interval between the two outer grippers is carried out twice as rapidly and twice as far as that of the two inner grippers. As a result, as one advantage, the containers being moved do not collide with one another, and the spacing intervals between adjacent grippers at the end of the procedure are of equal size.

A further advantageous embodiment of the invention makes provision that, during steps d and/or e, a different change in the spacing intervals of the grippers from the pivot axis takes place, and this change is reversed during steps i and/or j. As a result, the advantages are attained as referred to heretofore regarding the movement of the grippers along their longitudinal axis.

A further advantageous embodiment of the invention makes provision for the pivoting of the gripper unit takes place about the pivot axis by 180°. As a result, at the inlet of the containers standing on the conveying device, with their openings directed vertically upwards, they are rotated in such a way that their openings are then directed vertically downwards. In such an alignment, the coating of the containers by means of the coating process can be well carried out.

A further advantageous embodiment of the invention makes provision for the treatment station to comprise two separate part stations, a first part station and a second part station, and for the conveying device to comprise two parts, an inlet conveying device and an outlet conveying device, wherein the gripper unit always takes up the containers from the inlet conveyor device and always sets them down on the outlet conveyor device, and the gripper unit carries out the steps b to f or h to j related to the part station, but specifically step g is not carried out. As a result, the advantages are attained referred to heretofore with regard to the division of the conveying.

All the features described in the sub-claims of the advantageous further embodiments are part of the invention, in each case individually as well as in any desired combinations.

Further details and advantages of the invention are explained in greater detail on the basis of exemplary embodiments represented in the drawings.

### BRIEF DESCRIPTION OF THE DRAWINGS:

The Figures show:

FIG. 1 A perspective view of a transfer device according to the invention,

FIG. 2 a perspective view of a second gripper from FIG. 1,

FIG. 3 a perspective view of a first gripper from FIG. 1,

FIG. 4 a perspective view of a gripper frame according to the invention, together with carriages,

FIG. 5 a perspective view of a conveying device.

### DETAILED DESCRIPTION OF THE EMBODIMENTS:

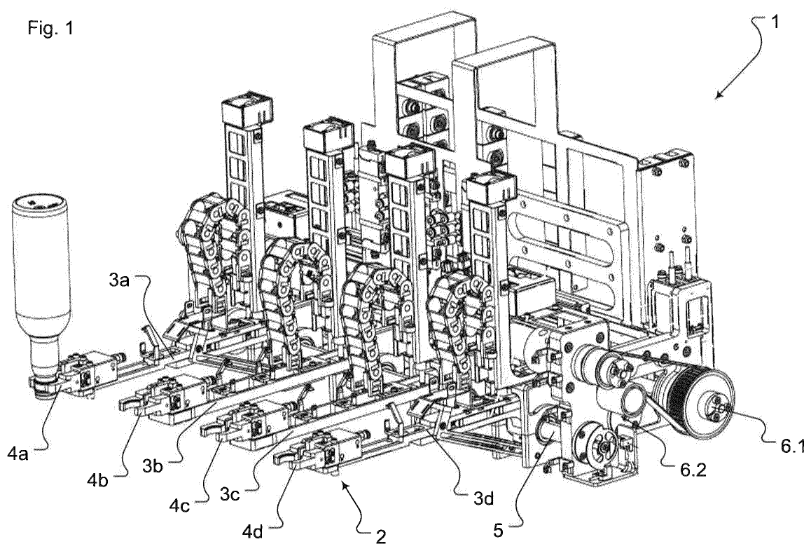

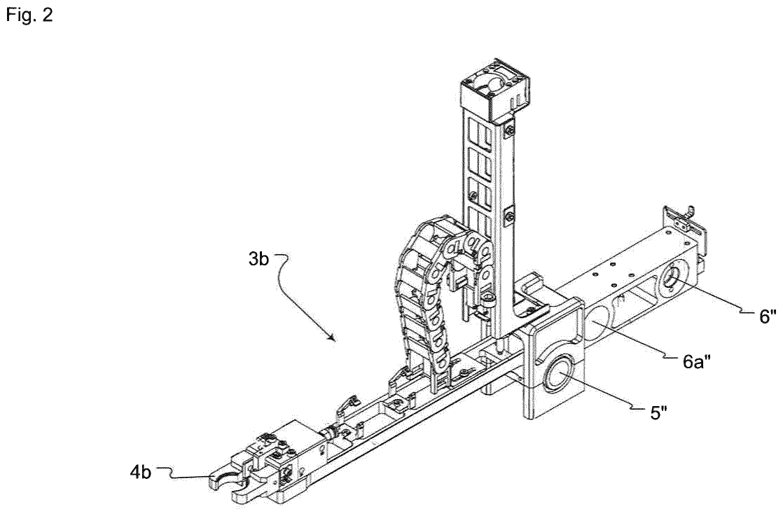

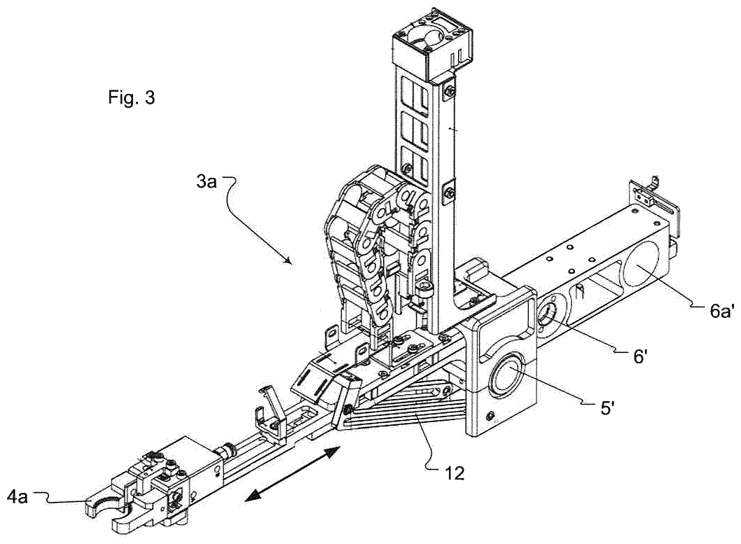

FIG. 1 shows a transfer station 1 with a gripper unit 2, which comprises, by way of example, four grippers 3a, 3b, 3c, 3d, which are present essentially present in two different design formats: Two outer grippers 3a, 3d (see FIG. 3) and two inner grippers 3b, 3c (see FIG. 2). Each gripper 3a, 3b, 3c, 3d comprises at its end gripping tongs 4a, 4b, 4c, 4d for active gripping and releasing a container 17 (in this case a PET bottle).

The grippers 3a, 3b, 3c, 3d can be pivoted about a pivot axis 5 in relation to the remainder of the gripper unit 2. Further details of this are provided hereinafter in connection with the description of FIGS. 2 and 3. In this situation, on the right an inlet or outlet transporter would be arranged, and on the left the actual treatment station. FIG. 1 therefore shows the situation with the containers 17 in the overhead position, respectively immediately before and after introduction into and removal from the respective treatment station.

At the takeover the containers 17 are delivered standing upright, which are guided on both sides by a railing 14, the grippers 3a, 3b, 3c, 3d or, respectively, the gripper group, must as a rule run through the following movement steps: To bridge the inner guide railing, a lifting movement, a horizontal return movement, a vertical pivoting into the overhead position of the container 17, a horizontal advance movement, if necessary a vertical lowering movement in order to set the container 17 into the treatment station, and a gripper opening and withdrawal of the empty gripper 3a, 3b, 3c, 3d, in order for the treatment station to be closed. The withdrawal of the containers 17 from the treatment station takes place in an analogous manner.

Also to be seen are a first longitudinal adjustment spindle 6.1 and a second longitudinal adjustment spindle 6.2, which serve to change the spacing intervals between the individual grippers 3a, 3b, 3c, 3d. For this purpose, the first longitudinal adjustment spindle 6.1 is driven by a toothed belt. By means of a gear arrangement, not shown, with a ratio of 1:2 between the first longitudinal adjustment spindle 6.1 and the second longitudinal adjustment spindle 6.2, the second longitudinal adjustment spindle 6.2 is driven at twice the speed. More details are provided in this respect hereinafter, in connection with the description of FIGS. 2 and 3.

Represented in FIG. 2 is one of the two inner grippers 3b, 3c, enlarged and without the remainder of the gripper unit 2; this is the second gripper 3b. This comprises at its left end the second gripper tongs 4b, with which it can grip the container 17 (as represented in FIG. 1).

The pivot movement of the second gripper 3b takes place about the pivot axis 5 represented in FIG. 1, which grips through a pivot axis sleeve 5″. The drive for the pivot movement is known to the person skilled in the art, and is therefore not described here.

Formed to the right of the pivot sleeve 6″ is a region which allows for a change in the spacing interval of the grippers 3a, 3b, 3c, 3d, in the axial in relation to the pivot axis 5. For this purpose, a second opening 6a″ and a second thread 6″ are provided. Through the first opening 6a″ the second longitudinal adjustment spindle 6.2 engages, and through the second thread 6″ the first longitudinal adjustment spindle 6.1 (both longitudinal adjustment spindles 6.1, 6.2 are represented in FIG. 1). The second longitudinal adjustment spindle 6.2 has a degree of play in the second opening 6a″, and therefore does not take effect on the second gripper 3b; however, the first longitudinal adjustment spindle 6.1 interacts with the second thread 6″, and has the effect that the second gripper 3b in FIG. 1 is moved to the left. This movement takes place at the rotation speed of the first longitudinal adjustment spindle 6.1.

The third gripper 3c is essentially configured in the same way as the second gripper 3b represented in FIG. 2. One substantial difference pertains, however, in that, instead of the second thread 6″, a third thread is configured in such a way that the movement of the third gripper 3c in FIG. 1 to the right takes place at the same speed as the second gripper 3b is moved in the opposite direction.

Represented in FIG. 3 is one of the two outer grippers 3a, 3d, enlarged (to the same scale as the second gripper 3b in FIG. 2) and without the remainder of the gripper unit 2; this relates to the first gripper 3a. This comprises at its left end the first gripper tongs 4a, with which it can grip the container 17 (as represented in FIG. 1).

The pivot movement of the first gripper 3a takes place about the pivot axis 5, represented in FIG. 1, which grips through a pivot axis sleeve 5′. The drive for the pivot movement is known to the person skilled in the art, and is therefore not described here.

The first gripper 3a exhibits two significant differences in relation to the second gripper 3b.

The first difference consists of the fact that the arrangement of opening and thread is exchanged in relation to the second gripper 3b. Where the second opening 6a″ was with the second gripper 3b, with the first gripper 3a there is a first thread 6′, and where the second thread 6″ was, there is a first opening 6a′. This means that the first longitudinal adjustment spindle 6.1 does not interact with the first gripper 3a, but instead engages through this with a degree of play. The second longitudinal adjustment spindle 6.2, however, interacts with the first gripper 3a by way of the first thread 6′, in such a way that the first gripper 3a in FIG. 1 is moved to the left. This movement takes place at double the speed of rotation in comparison with the first longitudinal adjustment spindle 6.1, since, by way of the drive arrangement described heretofore, the second longitudinal adjustment spindle 6.2 exhibits double the speed of rotation. As a result, the spacing interval of the first gripper 3a to the mid-point between the second gripper 3b and third gripper 3c is always twice as great as the spacing interval of the second gripper (the same also applies to the third gripper 3c on the basis of the explanations heretofore). It accordingly follows that the spacing interval of the first gripper 3a from the second gripper 3b is always the same distance as the spacing interval between the second gripper 3b and the third gripper 3c.

For the fourth gripper 3d, it essentially applies that it exhibits the same change from the first gripper 3a as the third gripper 3c from the second gripper 3b: Its fourth thread, which is formed on it instead of the first thread, is configured in such a way that a movement of the fourth gripper 3d takes place in the opposite direction to that of the first gripper 3a, i.e. in FIG. 1 to the right. It also follows from this that the spacing interval of the fourth gripper 3d from the third gripper 3c is always the same distance as the spacing interval of the second gripper 3b from the third gripper 3c. Accordingly, adjacent grippers 3a, 3b, 3c, 3d, in each case have the same spacing interval from one another.

As a result of this simple, synchronised spacing interval change, it is possible on the one hand to avoid the possibility of the containers 17 striking against one another during the pivot movement, and, on the other, it is possible, as a result of this, for containers 17 of substantially different sizes to be processed without the need for modifications to be made to the conveying device 13 or to the treatment station. The change in the spacing interval is necessary in particular with the processing of containers 17 of different sizes, since the spacing interval of the treatment positions in the treatment station could only be changed with very great effort, but the spacing interval between the containers 17, which are regularly of very different sizes when entering on the conveying device 13, is also very different. This difference in size is compensated by the movement of the conveying device 13 to the treatment station; the same applies to the return path.

A further significant difference between the first gripper 3a and the second gripper 3b consists of the fact that it can be changed in length along its longitudinal axis; this is shown in FIG. 3 by way of a double arrow. The capacity for changing in length is achieved by the fact that a drawbar 12 is arranged between the part in which the pivot axis sleeve 5′ is formed and the part which points horizontally to the left in FIG. 3, arranged at which, at the front end, is the first gripper tongs 4a, this drawbar interacting with corresponding mechanical components on the two parts referred to in such a way that the change in length of the first gripper 3a takes place, as referred to. Such mechanical arrangements are known to the person skilled in the art. Due to the change in length, the first gripper tongs 4a move parallel to the double arrow along the longitudinal axis of the first gripper 3a.

The fourth gripper 3d comprises essentially the same device for changing length along its longitudinal axis as that of the first gripper 4a. Accordingly, the gripper tongs 4a, 4b, 4c, 4d are located not in a straight line but on a circular line segment. Accordingly, treatment stations can be easily be loaded with containers 17 of which the treatment positions are not located in a straight line in relation to one another, but on a circular line segment.

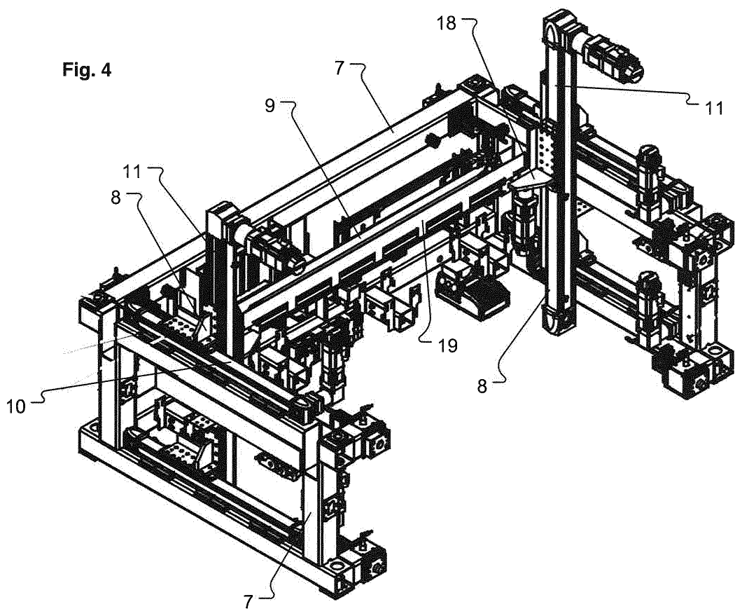

Represented in FIG. 4 on a reduced scale is a gripper frame 7, arranged at which are carriages 8. Conversely, the transfer device 1 is not mounted on the device represented. It would be secured on a carrier 19, which defines the X-axis 9 of the carriage 8 and extends in the horizontal direction.

The gripper frame 7 comprises two U-shaped carrier arrangements, which are aligned horizontally and arranged vertically above one another. These are connected securely to one another by means of vertical braces.

The carriage 8 is located on this very stable gripper frame 7 in such a way that it can be moved inside the gripper frame 7. This allows for movements of the transfer device 1 after installation along the X-axis 9, a Y-axis 10 extending likewise horizontally to this, and, perpendicular to this and running vertically, a Z-axis 11. Added to this is the possibility of the transfer device 1 being pivoted about the pivot axis 5, which is aligned parallel to the X-axis 9. Furthermore, the two outer grippers 3a, 3d, are also changeable in length along their respective longitudinal axes. Finally, the spacing intervals of the grippers 3a, 3b, 3c, 3d, between one another can also be changed along the pivot axis 5.

Due to this wide range of possible movements, containers 17 which are taken up by the transfer device 1 from the conveying device 13 are brought rapidly, reliably, and flexibly to a treatment station, coated there, and then set back on the conveying device 13 again. The method steps referred to heretofore in the part with the general description and the claims can be carried out very well with such a device. The treatment station, not represented in FIG. 4, is located, however, in the region between the free limbs of the U-shaped gripper frame 7, such that it can be easily reached by the grippers 3a, 3b, 3c, 3d, in order to bring the containers 17 into it there for the coating, and to fetch them out again after coating has been carried out.

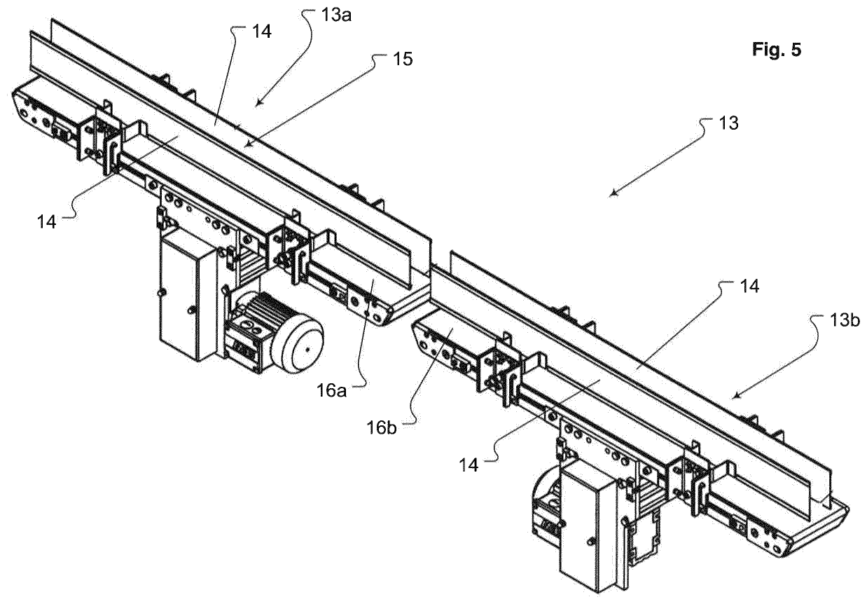

Represented in FIG. 5, not to scale, is a conveying device 13, which in the installed state is located at least with a part length inside the main frame, not represented, and parallel to the X-axis 9 between the carrier 19 of the carriage 8 and the middle carrier of U-shaped gripper frame 7 (which in FIG. 1 can be seen on the far left running obliquely running from bottom left to top right). This conveying device 13 can be arranged in its entirety or at least with a part length as an integral constituent part of the coating machine, or, for example, immediately in front of the head in the operational range of the grippers 3a, 3b, 3c, 3d.

This conveying device 13 is of two parts. It is divided into an inlet conveying device 13a with a first conveyor belt 16a, and an outlet conveying device 13b with a second conveyor belt 16b, wherein the two conveyor belts 16a, 16b, can be moved independently of one another. Over each conveyor belt 16a, 16b, is in each case a channel 15, which is formed in each case by two railings 14 standing upright. The spacing intervals between the railings 14 can be changed, such that the width of the channel 14 can be varied, and can be adjusted to the size of the containers 17 which are to be treated, such that their forwards movement takes place with only a little play between the railings 14. This prevents the containers 17 from falling over.

In another embodiment, the railing 14 facing towards the transfer device 1 can be lowered or folded away. This means that, after the taking up of the containers 17 by the gripper unit 2, it is only minimally necessary for the transfer device 1 to be moved upwards (along the Z-axis 11); any further movement upwards in order to raise it out of the channel 15 is not necessary, which saves time.

After the containers 17 have been treated and are intended to be advanced further in the production line, they must be set down on the second conveyor belt 16b of the outlet conveyor device 13b. During the setting down procedure, the second conveyor belt 16b can be stopped, although the first conveyor belt 16a continues running and conveys further containers 17 into the system. The stopping prevents the possibility of containers 17 falling over when being set down on a running second conveyor belt 16b.

The drive variant described heretofore of the grippers 3a, 3b, 3c, 3d, is very economical and effective. As an alternative, for each gripper 3a 3b, 3, 3d, an individual drive with a suitable control arrangement can be provided on each gripper 3a, 3b, 3c, 3d, for transverse adjustment in relation to one another, such that each gripper 3a, 3b, 3c, 3d, can be moved transversely independently of the others.

These can be, for example, servomotors which are configured as external-rotor motors, and which, for example, run on a common spindle. As an alternative, an electromagnetic direct drive can be provided, with which each gripper 3a, 3b, 3c, 3d, is carried on a movement carriage and is moved with this, wherein each movement carriage can be controlled and regulated independently of the others, wherein ideally the carrier running transversely also forms the stator and drive.

Furthermore, the number of four grippers of a group is naturally only an embodiment variant. Advantageously, groups with two to 12 grippers are provided, depending on the number of the treatment stations or wide range of formats of the containers which are to be treated.

### REFERENCE NUMBER LIST

1 Transfer device
2 Gripper unit
3a First gripper
3b Second gripper
3c Third gripper
3d Fourth gripper
4a First gripper tongs
4b Second gripper tongs
4c Third gripper tongs
4d Fourth gripper tongs
5 Pivot axis
5′,5″ Pivot axis sleeve
6.1 First longitudinal adjustment spindle
6.2 Second longitudinal adjustment spindle
6′ First thread for longitudinal adjustment spindle
6″ Second thread for longitudinal adjustment spindle
6a′ First opening for longitudinal adjustment spindle
6a″ Second opening for longitudinal adjustment spindle
7 Gripper frame
8 Carriage
9 X-axis
10 Y-axis
11 Z-axis
12 Drawbar
13 Conveying device
13a Inlet conveying device
13b Outlet conveying device
14 Railing
15 Channel
16a First conveyor belt
16b Second conveyor belt
17 Container
18 Holder
19 Carrier

1. A device for coating containers by means of a coating process,
with a main carrier frame, wherein the following units are present inside the main carrier frame:
a treatment station for coating the containers,
a transfer device, which moves the containers between at least one conveying device and treatment station,
wherein the units also comprise the at least one conveying device or can be connected to the at least one conveying device,
wherein the transfer device comprises a gripper unit, which is located such as to be able to pivot along a pivot axis aligned parallel to the conveying device on a gripper frame, which during operation of the device is arranged secured to the main carrier frame and/or is part of the main carrier frame,
wherein the gripper unit can be moved between a first position, in which it can grip the containers in the region of the conveying device, and a second position, in which it can place the containers into the treatment station and fetch them out of it.

2. The device according to claim 1, wherein the gripper unit is located on a carriage connected to the gripper frame, and the carriage can carry out linear movements in three directions running perpendicular to one another.

3. The device according to claim 1, wherein the conveying device comprises two parts, an inlet conveying device and an outlet conveying device, and/or the treatment station comprises two separate part stations, a first part station and a second part station.

4. The device according to claim 1, wherein, when not in operation, the gripper frame and the transfer device attached to it can be lowered in relation to the main carrier frame.

5. The device according to claim 1, wherein the gripper unit comprises a group of grippers which can be moved towards one another, in particular a group of 2 to 12 grippers.

6. The device according to claim 4, wherein the spacing interval between adjacent grippers can be changed axially to the pivot axis.

7. The device according to claim 4, wherein the grippers can be moved along their longitudinal axis.

8. The device according to claim 1, wherein, inside the main carrier frame of the devices there is also at least one conveying device present with at least one part section.

9. The device according to claim 1, wherein the conveying device has a railing, with which at least the part arranged on its side facing towards the treatment station can be lowered or pivoted away.

10. A method for operating a device according to any one of the preceding claims, with the following steps:
input conveying of the containers by the conveying device;
gripping of the containers by the gripper unit (2) on the conveying device;
raising of the gripper unit together with the containers;
pivoting the gripper unit about the pivot axis;
linear moving of the gripper unit until the containers are located in the treatment station;
releasing the containers by the gripper unit;
carrying out the coating;
gripping the containers by the gripper unit in the treatment station;
linear movement and pivoting of the gripper unit until the containers are located above the conveying device;
placing the containers on the conveying device and releasing them by the gripper unit;
outlet conveying of the containers by the conveying device.

11. The method according to claim 10, wherein, during steps d and/or e, a change takes place in the spacing intervals between adjacent grippers axially to the pivot axis, and this change is made reversible during steps i and/or j.

12. The method according to claim 11, wherein the gripper unit comprises four grippers, and the change in spacing interval of the two outer grippers is carried out twice as rapidly and twice as far as that of the two inner grippers.

13. The method according to claim 10, wherein, during steps d and/or e, a different change in the spacing interval of the grippers from the pivot axis, and this change is made reversible during steps i and/or j.

14. The method according to claim 10, wherein the pivoting of the gripper unit about the pivot axis takes place through 180°.

15. The method according to any one of claims 10, wherein the treatment station comprises two separate part stations, a first part station and a second part station, and the conveying device comprises two parts, an inlet conveying device and an outlet conveying device, wherein the gripper unit always takes the containers from the inlet conveying device and always sets them down on the outlet conveying device, and the gripper unit carries out the steps b to for h to j, related to the part station, whereby step g is specifically not carried out.
